(19) United States
(12) Patent Application Publication
(10) Pub. No.: US 2026/0078749 A1
(43) Pub. Date: Mar. 19, 2026

(54) SYSTEM AND METHOD FOR HIERARCHICAL COMPRESSOR CONTROL

(71) Applicants: Atlas Copco Airpower, Naamloze Vennootschap, Wilrijk (BE); KATHOLIEKE UNIVERSITEIT LEUVEN, Leuven (BE)

(72) Inventors: Ramin Abbasi ESFEDEN, Wilrijk (BE); Wim VAN ROY, Wilrijk (BE)

(21) Appl. No.: 19/310,572

(22) Filed: Aug. 26, 2025

Related U.S. Application Data
(60) Provisional application No. 63/695,578, filed on Sep. 17, 2024.

(51) Int. Cl. F04B 49/06; G05B 13/04

(52) U.S. Cl. CPC F04B 49/065; G05B 13/047; G05B 13/048

(57) ABSTRACT

A method and system are provided at a local network level and a remote cloud level. The local network level includes compressors and a controller configured to create a short-term schedule having a short-term switching sequence for operation of the compressors, perform a validation assessment on the short-term schedule, and send the short-term schedule to a platform embedded with the main controller of the system. A prediction model, a long-term scheduling approach, and cloud storage that stores measurements from the compressors and executable instructions are provided at the remote cloud level. The long-term schedule is transferred to a safety check module at the local network level. Following validation, the embedded platform refines the long-term switching sequence and the safety check module allows the system to implement the long-term schedule, having the short-term schedule as a backup option.

### INCORPORATION BY REFERENCE TO RELATED APPLICATIONS

The present disclosure incorporates herein by reference the following: International application No. PCT/IB2021/058007, filed on Sep. 2, 2021, and published as WO 2022/064299 A1 on Mar. 31, 2022; International application No. PCT/EP2021/073675, filed on Aug. 26, 2021, and published as WO 2023/025393 A1 on Mar. 2, 2023; and International application No. PCT/IB2023/062859, filed on Dec. 18, 2023, and published as WO 2024/141848 A1 on Jul. 4, 2024.

### FIELD OF THE DISCLOSURE

The present disclosure relates to methods, systems, and apparatuses for online monitoring and controlling a compressor system, particularly for monitoring, controlling, and optimizing the efficiency of components of a compressor system for providing compressed air or gases to consumers.

### BACKGROUND

It is known that compressors are used to compress air or gases in one or more compression stages. The compressed air or gas is then provided to one or more consumers. The distribution thereof may be provided through a compressed air or gas system. Since the number of consumers may be vast and spatially distributed over a significant area, for example, in an industrial plant or a hospital, a central hub is usually installed to provide compressed air or gases.

A central hub normally comprises one or more compressor rooms wherein one or more compressors are installed in each room. Further, auxiliary devices such as valves, filters, dryers, vessels, sensors, controlling components, and/or other devices for managing and/or controlling the compressor rooms are likewise installed. Next, from one or more compressor rooms onward, pipes or ducts are used to supply consumers with compressed air or gas. As a last part of the supply chain, compressed air or gas is utilized by consumers for a variety of applications.

Furthermore, between the compressors and the consumers, another set of devices may also be present, such as safety valves, distribution valves, control sensors, or other devices for controlling and safeguarding the distribution of compressed air or gases.

The described setup will further be identified as a compressor system. Hence, a compressor system may comprise one compressor supplying one consumer but will generally be regarded as more extensive, thus comprising a multitude of components and constituting a complex system of several elements interacting.

The different parts of the compressor system need to be controlled to use it. It is known to separately control compressors by independent local controllers, whereby the different controllers are set at a predefined pressure value, switching the compressors sequentially on or off, e.g., depending on the consumption of compressed air.

It is further known to apply a method for controlling a compressed air or gas system by communicating controllers for controlling components that are part of the compressed air or gas system, whereby the components are controlled such that none of the controllers determines the operational condition of any component that other controllers control. For example, in WO 2008/009072, published Jan. 24, 2001, a method is disclosed for controlling a compressed air unit consisting of several compressed air or gas networks with at least one commonly controllable component. However, a disadvantage of such controlling methods is that they solely operate based on the current state of the compressed air or gas system, meaning that they are incapable of considering a prediction of any kind. These methods lead to suboptimal control and higher energy costs.

A compressor system may be provided as a switched dynamical system or a continuous-time nonlinear system defined by multiple subsystems and nonlinear switching rules. Switched dynamical systems show a large flexibility in modeling a wide range of real-world applications; however, due to the discrete nature of switched dynamics, it has proven difficult to realize advantageous control of such a system. Such existing systems are overly complex, requiring significant computational capacity and time delay due to the intricate computations, and can still be inaccurate.

There is a need for an improved method for controlling a compressed air or gas system using an efficient model for calculating more optimal switching times and greater future demand prediction capabilities.

### SUMMARY

The present disclosure provides a system and method to remedy one or several of the above-mentioned and other disadvantages by introducing a robust hierarchical online compressor control model. The disclosed system and method are generally associated with a compressor room having one or more compressors that work to deliver compressed air or gas to various consumers, i.e., in different physical locations. A central controller is provided to schedule and control various operations of one or more compressors to optimize and distribute the load required for the consumers. To achieve the highest energy savings in the compressor air system, the central or decentralized compressor room controller should consider a long-term horizon to schedule compressors efficiently. This long-term horizon should consider a compressor's “worst-case” minimum cycle time, which can take up to 8 hours and lead to a complicated mixed integer problem to solve in real-time.

Existing state-of-the-art compressor systems do not consider a future horizon to schedule compressors efficiently. Moreover, the current state-of-the-art algorithms are not fast enough to solve complicated mixed integer problems in real-time. The main objective of the present disclosure is to introduce a solution that improves the overall energy efficiency of compressed air systems while achieving robustness and safety. The present disclosure proposes a system and method that efficiently splits the control problem of compressed air systems into manageable, smaller scheduling and prediction problems that a hierarchical compressor control system can solve.

In a first aspect, a method is provided for controlling a compressed air or gas system, including one or more compressors configured to provide compressed air or gas to one or more consumers. At a local network level of the compressed air or gas system, the method includes the steps of obtaining measurements from one or more compressors for estimating the current state of the one or more compressors, transmitting the measurements to a remote cloud level or cloud computing environment of the compressed air or gas system, transmitting the measurements to a short-term scheduling model to create a short-term schedule having a short-term switching sequence for operation of the one or more compressors, performing a validation assessment on the short-term schedule for feasibility and safety using a safety check module, and sending the short-term schedule, following validation, to a platform embedded with a controller of the compressed air or gas system, wherein the platform is arranged to refine the short-term switching sequence before implementation on the one or more compressors using switching time optimization.

At the remote cloud level of the compressed air or gas system, the method includes the steps of storing the measurements from one or more compressors in a cloud storage, producing a future demand prediction for the one or more compressors using a prediction module based on stored measurements in the cloud storage, transmitting the future demand prediction to a long-term scheduling model to create a long-term schedule having a long-term switching sequence for operation of the one or more compressors, and transmitting the long-term schedule to the local network level of the compressed air or gas system. The method further includes performing the validation assessment on the long-term schedule for feasibility and safety, using the safety check module, and sending the long-term schedule to the embedded platform on the controller of the compressed air or gas system following validation.

The long-term scheduling model creates multiple long-term schedules based on multiple future demand predictions. In other words, the cloud computes multiple possible schedules depending on different forecasts. The long-term schedule transmitted to the local network level of the compressed air or gas system is selected from the multiple long-term schedules and derived from the future demand prediction with a most probable outcome, i.e., the most probable results will be shared with the main controller.

Long-term scheduling is based on a plant model together with a prediction module. The method determines the most probable outcome by solving a mixed integer problem based on costs, requirements, and constraints associated with one or more compressors. In an embodiment, the future demand prediction is determined from the prediction module using artificial intelligence (AI) or a regression model. The mixed integer problem is solved using dynamic programming, analytical dynamic programming (ADP), genetic algorithms, a heuristic, a branch and bound scheme, an advanced mixed-integer nonlinear programming (MINLP) solver, a linear program simplex solver and cutting algorithms, or iterative switch time optimization (iSTO).

The safety check module is arranged to implement the long-term switching sequence by default following validation of the long-term schedule. The safety check module further prevents the long-term schedule from being sent to the embedded platform in response to an invalid result obtained from the validation assessment for said long-term schedule. After obtaining the invalid result for the long-term schedule, the safety check module implements the short-term switching sequence as a fallback position. The safety check module evaluates the long-term schedule based on the measurements from one or more compressors obtained to estimate the current state of one or more compressors. The safety check module is also arranged to automatically determine whether to implement the long-term or short-term switching sequence to operate one or more compressors based on the validation assessment. If there is a communication failure between the cloud and the main controller, the safety check module is arranged to implement the best available schedule strategy within the safe local network.

Based on the assessment of the safety check module, a short-term model predictive control (MPC) based control algorithm refines the proposed schedule and computes the required setpoints and actions of the compressors in the local network. In an embodiment, the MPC control algorithm is implemented using a heuristic combined with quadratic programming or non-linear programming, switch time optimization (STO), or dynamic programming.

The short-term switching sequence represents a unique sequence of operations of one or more compressors within a future period of 1 minute to 60 minutes, preferably less than 45 minutes or less than 30 minutes. The long-term switching sequence represents a unique sequence of operations of the one or more compressors within a future period of 1 hour to 1 week, preferably greater than the minimum cycle time of the one or more compressors, e.g., 8 hours. The long-term schedule is recomputed at least once during every short-term switching sequence. The short-term controller recomputes the setpoints and reschedules the actions of the compressors, e.g., every 20 ms to 10 seconds. In an embodiment, the sampling time of the short-term schedule is the same as its loop-time and depends on the system dynamics.

In another aspect, a hierarchical compressor control system is provided comprising, at a local network level of the system, one or more compressors configured to provide compressed air or gas to one or more consumers and a main controller including at least one processor and one or more hardware storage devices that store executable instructions. The instructions are executable to cause the controller to obtain measurements from one or more compressors for estimating the current state of the one or more compressors, transmit the measurements to a remote cloud level of the system, transmit the measurements to a short-term scheduling model to create a short-term schedule having a short-term switching sequence for operation of the one or more compressors, perform a validation assessment on the short-term schedule for feasibility and safety using a safety check module, and send the short-term schedule (i.e., following validation) to a platform embedded with the main controller of the system, wherein the platform is arranged to refine the short-term switching sequence before implementation on the one or more compressors using switching time optimization.

The system further comprises, at the remote cloud level of the system, a prediction model, a long-term scheduling approach and cloud storage that stores specifications of the installation and measurements from one or more compressors and further stores executable instructions. The instructions in the cloud storage are the execution of a prediction based on the stored measurements and the computation of one or more long-term switching sequence for the operation of the one or more compressors, and transmit the long-term schedule to the local network level of the system.

The controller is further configured to perform the validation assessment on the long-term schedule for feasibility and safety using the safety check module and send the long-term schedule, following validation, to the platform embedded with the controller of the system, wherein the platform is arranged to refine the long-term switching sequence before implementation on the one or more compressors using switching time optimization. Based on the validation assessment, the safety check module is arranged to automatically determine whether to implement the long-term or short-term switching sequence for operation of the one or more compressors.

In another aspect, a controller is provided and configured to operate a compressor system with one or more compressors. The controller comprises a processor and a computer-readable storage medium that stores executable instructions. Said instructions are executable to cause the controller to obtain measurements from the one or more compressors for estimating a current state of the one or more compressors, transmit the measurements to a remote cloud level of the compressor system, transmit the measurements to a short-term scheduling model to create a short-term schedule having a short-term switching sequence for operation of the one or more compressors, perform a validation assessment on the short-term schedule for feasibility and safety using a safety check module, send the short-term schedule, following validation, to a platform embedded with the controller of the compressor system, wherein the platform is arranged to refine the short-term switching sequence before implementation on the one or more compressors, receive a long-term schedule originating from the remote cloud level of the compressor system and generated using a prediction module and the long-term scheduling model at remote cloud level of the compressor system, perform the validation assessment on the long-term schedule for feasibility and safety using the safety check module, and send the long-term schedule, following validation, to the platform embedded with the controller of the compressor system, wherein the platform is arranged to refine the long-term switching sequence before implementation on the one or more compressors using switching time optimization. Moreover, based on the validation assessment, the safety check module is arranged to automatically determine whether to implement the long-term or short-term switching sequence for the operation of one or more compressors.

By hierarchically providing a split-system arrangement, wherein a long-term schedule and future prediction are generated in a cloud environment and a short-term schedule is generated in a local network environment, the compressors' control is safe and efficient. Safety checking in the main controller is done to verify that the schedule or plan produced in the cloud environment is safe to use at the local level, which can protect the physical hub and/or compressors from cyberattacks and hacking. Also, by validating the feasibility of the schedule strategy, the physical hub is prevented from implementing impracticable operations.

This summary is provided to introduce a selection of concepts in a simplified form that are further described below in the Detailed Description. These and other features, aspects, and advantages of the present disclosure will be better understood in the following description, appended claims, and accompanying drawings.

### BRIEF DESCRIPTION OF THE DRAWINGS

A more particular description of the embodiments briefly described above will be rendered by reference to specific embodiments, illustrated in the appended drawings to describe how the advantages and features of the systems and methods described herein can be obtained. Understanding that these drawings depict only typical embodiments of the systems and methods described herein and are not to be considered limiting in their scope, certain systems and methods will be described and explained with additional specificity and detail through the accompanying drawings.

FIG. 1 illustrates a schematic diagram of a compressor system.

FIG. 2 illustrates a perspective view of a physical hub for the compressor system.

FIG. 3 illustrates a schematic model of the local network level and the remote cloud level of the compressor system.

### DEFINITIONS

For ease of understanding the disclosed embodiments of the present disclosure, a description of a few terms is necessary.

The term “cloud” or “cloud environment” refers to all cloud offerings and infrastructure-as-a-service (IaaS), as well as all platform-as-a-service (PaaS) and software-as-a-service (SaaS) applications. A cloud environment may encompass hardware, software (including hardware and software configuration), networking, and executing workloads. The term “cloud environment” may also encompass a cloud storage or cloud service storage, which enables convenient, on-demand network access to configurable computing resources (e.g., networks, servers, applications) that can be rapidly executed with minimal management or provider interaction.

The term “compressor” refers to a machine that draws low-pressure gas from auxiliary storage as raw input and then outputs high-pressure gas for storage or to feed other processes. The terms “compressor” and “compressor elements” are not intended to be limiting in scope and may refer to positive displacement compressors and/or turbocompressors and/or individual components of compressors.

The term “computer storage media” refers to physical storage media that store computer-executable instructions and/or data structures. Storage media, such as a digital data carrier, includes computer hardware, such as random access memory (RAM), read-only memory (ROM), electrically erasable programmable ROM (EEPROM), solid state drives (SSDs), flash memory, phase-change memory (PCM), optical disk storage, magnetic disk storage, and the like.

The term “controller” generally refers to a computerized command terminal comprising sensors and electrical components to regulate various compressor instruments or elements e.g., variable speed drives (VSDs). In general, controllers include or are electrically connected to at least one main computing unit with a graphical interface and are adapted to monitor the instrumentation of various compressor components (e.g., motors, rotors, filters, bearings, valves, pressure sensors, temperature sensors), including multiple compressors. Exemplary controllers operate to collect data from sensors within the VSD and/or motor, processing said and delivering an overview. Controllers may be connected to mobile devices, such as tablets and smartphones, to allow for mobile monitoring over a secure network. Controllers may also allow for over-the-air updates from a service or cloud environment.

The term “network” refers to one or more data links that enable the wired or wireless transport of electronic data between computer systems and/or cloud environments and/or modules and/or other electronic devices.

The term “processor” or “computing unit” refers to one or more devices, circuits, and/or processing cores configured to process data, such as computer program instructions, and includes personal computers, desktop computers, laptop computers, message processors, hand-held devices, multi-processor systems, microprocessor-based or programmable consumer electronics, network PCs, minicomputers, mainframe computers, mobile telephones, PDAS, tablets, pagers, routers, switches, and the like. Unless otherwise stated, references to a first processor may also apply to a second processor and vice versa.

The term “schedule” refers to a plan for carrying out a process or procedure, including a sequence of operations, e.g., performed by one or more compressors, and predetermined times at which the operations are to be performed.

The term “service” refers to an automated program that performs different actions based on input. As used herein, the terms “executable module,” “executable component,” “component,” “model,” “module,” “service,” or “engine” can refer to hardware processing units or to software objects, routines, or methods that may be executed on with the system.

The term “software” generally refers to computer-executable instructions, code, data, applications, programs, program modules, or the like maintained in or on any form or type of computer-readable media that is configured for storing computer-executable instructions or the like in a manner that is accessible to a computing device.

As used herein, reference to any type of machine learning or artificial intelligence may include any type of machine learning algorithm or device, convolutional neural network(s), multilayer neural network(s), recursive neural network(s), recurrent neural network(s), deep neural network(s), decision tree model(s) (e.g., decision trees, random forests, and gradient boosted trees) linear regression model(s), logistic regression model(s), support vector machine(s), artificial intelligence device(s), or any other type of intelligent computing system. Any training data may be used (and perhaps later refined) to train the machine learning algorithm to perform the disclosed operations dynamically.

When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. A single prime or double prime designation with the same reference number is used for the same or similar structures, i.e., component 10′ and component 10″ are the same as or similar to component 10.

### Solver Approaches

As noted above, the term “schedule” refers to a plan for carrying out a process or procedure, including a sequence of operations, e.g., performed by one or more compressors, and predetermined times at which the operations are to be performed. In other words, a schedule includes a sequence of compressors selections and the time duration for which we keep the same selection. Each compressor selection within the sequence is referred to as a stage and the time duration of each stage is referred to as the dwell time of that stage. For example, in a system having three compressor units:

| Unit 1 | OFF | OFF | UNLOAD |
|---|---|---|---|
| Unit 2 | LOAD | UNLOAD | OFF |
| Unit 3 | LOAD | LOAD | LOAD |
| Time | 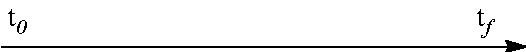 | | |
| Stage | s₁ | s₂ | s₃ |
| Dwell Time | w₁ | w₂ | w₃ |

The schedule above is characterized by two vectors:

$$s = ( {s}_{1} , {s}_{2} , {s}_{3} ) ∈ {ℕ}^{3}$$

where sx is a label number assigned to the specific compressor selection of stage k, and

$$w = ( {w}_{1} , {w}_{2} , {w}_{3} ) ∈ {ℝ}^{3}$$

where each wx is the dwell time of stage sₖ. The problem of optimal scheduling is to find the optimum tuple of (s*, w*), referred to as a schedule. The proposed schedule should satisfy the timing constraints of the compressors. For instance, a DSS timer would need the duration between each two stop to be lower bounded. For a specific s, this results in linear inequalities on w, known as dwell time constraints. For a fixed the problem of finding optimum times is a known continuous optimization, i.e., Switching Time Optimization (STO). However, finding s* is a complex combinatorial problem, where the number of stages and their order are not known beforehand. This problem may be referred to as Sequence Optimization (SO). Due to complexity of SO, there are various “schedulers” that may be implemented to approximate and/or optimize the approach. The following solver approaches may be implemented with the disclosed solution.

Mixed integer linear programming (MILP) is a straightforward method to address the SO problem. In this approach, future horizon t_{f} is discretized with a fixed sampling time Δt is a fixed grid. The states of the compressor controller can then be represented as a set of Boolean variables. The problem is formulated as

$${min}_{p , q , S} {\sum }_{k = 1}^{M} L ( {p}_{k} , {q}_{k} , {S}_{k} )$$

$${p}_{k + 1} = F ( {p}_{k} , {q}_{k} , {S}_{k} ) , ∀ k ∈ \{ 1 , 2 , … , M \} ,$$

$${p}_{1} = {\overline{p}}_{1} ,$$

$$S ∈ {\{ 0 , 1 \}}^{n , \times M}$$

$$H ( S , p , q ) \geq 0 ,$$

where L(pₖ, qₖ, Sₖ) calculates the cost function of the kth stage, and F(pₖ, qₖ, Sₖ) is the integrator of the dynamics, transitioning the system states from the beginning of stage k to the end of it (beginning of the stage k+1). For the system states, p∈R is pressure, and for continuous control inputs, q is the produced flow. H(S, p, q) captures the system constraints and transitions between the Boolean state variables. The set of states in the system is represented by S. The system constraints can often be simplified to linear constraints. Furthermore, the cost function L(pₖ, qₖ, Sₖ) is often a convex function which can be approximated by a set of lower bounds. The final problem can be solved using one of the existing MILP solvers such as CPLEX, Gubrobi, Highs, or cbc.

SO is not tractable in general as it is a combinatorial problem with a large feasible set, and brute enumeration is not a possibility. To make the problem tractable, the feasible set of SO is limited to a set of subsequences of an initial sequence. By doing so, one only needs to choose and take only the stages that are determined as being optimal.

For an embodiment of mixed integer programming on switched systems, s̅=(s̅₁, s̅₂, s̅₃, . . . , s̅_{M}) is the fixed initial sequence. Any subsequence of s can be singled out through a binary vector b∈B^{M} in such a way that s̅ᵢ is selected if and only if bᵢ=1. Therefore, the SO problem is to now find the optimum b* for a given s̅. The STO problem is to find the optimum w* for a given b. For the following equation, φ(b) is the optimal objective function of the STO:

$$ϕ ( b ) = {min}_{p , q , w} {\sum }_{k = 1}^{M} L ( {p}_{k} , {q}_{k} , {\overline{s}}_{k} , {w}_{k} )$$

$${p}_{k + 1} = F ( {p}_{k} , {q}_{k} , {\overline{s}}_{k} , {w}_{k} ) , ∀ k ∈ \{ 1 , 2 , … , M \} ,$$

$${p}_{1} = {\overline{p}}_{1} ,$$

$${\sum }_{k = 1}^{M} {w}_{k} = {t}_{f} ,$$

$$0 \leq {w}_{k} \leq {b}_{k} {t}_{f} ,$$

$$G ( w , b ) \geq 0 , ∀ I ∈ ,$$

where L(pₖ, qₖ, s̅ₖ, wₖ) calculates the cost function of the kth stage, and F(pₖ, qₖ, s̅ₖ, wₖ) is the integrator of the dynamics, transitioning the system states from the beginning of stage k to the end of it (beginning of the stage k+1). For the system states, p∈ [symbol] is pressure, and for continuous control inputs, q is the produced flow. Function G captures the dwell time constraints. G depends on b as each sequence has its own order of stages, and consequently, it can generate different constraints. The selection of stages is done by wₖ≤bₖt_{f} constraint. As bₖ becomes zero, i.e., it is desired to exclude the particular stage, the dwell time of that stage collapses to zero, effectively removing its effects from L and F. The effect of b still needs to be addressed within G. Based on φ(b), the SO problem can be written as

$${min}_{b ∈ {𝔹}^{M}} ϕ ( b )$$

The combination of SO and STO can be solved as mixed-integer nonlinear programming (MINLP) with on b and the integer variables. This MINLP can be solved by open source solvers, such as Bonmin.

The SO and STO described above, with respect to mixed integer programming on switched system, can be solved by a MINLP solver, an iterative algorithm approach (i.e., iterative switching time optimization) may be implemented to solve more efficiently. The G function in φ(b) can be replaced by a slacked version of dwell time constraints and a complementarity constraint between slacks and dwell times as follows:

$${ϕ}_{i s t o} ( b ) = {min}_{p , q , w , e} {\sum }_{k = 1}^{M} [ L ( {p}_{k} , {q}_{k} , {\overline{s}}_{k} , {w}_{k} ) + γ {e}_{k} {w}_{k} ]$$

$${p}_{k + 1} = F ( {p}_{k} , {q}_{k} , {\overline{s}}_{k} , {w}_{k} ) , ∀ k ∈ \{ 1 , 2 , … , M \} ,$$

$${p}_{1} = {\overline{p}}_{1} ,$$

$${\sum }_{k = 1}^{M} {w}_{k} = {t}_{f} ,$$

$$0 \leq {w}_{k} \leq {b}_{k} {t}_{f} ,$$

$${\sum }_{k ∈ I} {w}_{k} + {e}_{k} \geq Δ , ∀ I ∈ {b}_{} ,$$

where

$$e ∈ {ℝ}_{\geq 0}^{M}$$

is the slack vector. The complementarity constraint 0≤w⊥e≥0 is enforced by the penalty function γeₖwₖ, where γ is the penalty weight. [symbol] _{b} shows the dependency of dwell time constraints on b.

The proposed iterative algorithm allows for starting at b=1 and a small weight γ. This amounts to including all stages of s̅ and relaxing the dwell time constraints. Such provides a lower bound of the cost function. Subsequently, γ is slowly increased and bₖ=0 is set for any stage where wₖ becomes zero. The process is then repeated for the new b.

Another way to quickly receive a rough schedule is to use Dynamic Programming (DP). DP is an optimization method in which a complicated problem is solved by iteratively solving smaller, simpler subproblems. The so-called principle of optimality allows combining the optimal solution of the subproblems to find the optimal solution to the original problem. If a time grid to t₀≤t₁≤t₂≤ . . . t_{N}=t_{f} is selected over the total horizon of the schedule, and a stage sᵢ is assigned to each tᵢ, the principle of optimality can be applied to the compressor room system as follows:

$$V ( {s}_{i + 1} ) = min \{ c ( {s}_{i + 1} ) + V ( {s}_{i} ) \} i ∈ \{ 0 , 1 , 2 , … , N - 1 \}$$

$$V ( {s}_{0} ) = c ( {s}_{0} )$$

where V(sᵢ) is the cost-to-go from a stage sᵢ at tᵢ to s₀, and c(sᵢ) is the running cost for a stage sᵢ at tᵢ. The running cost c(sᵢ) includes the future demand prediction at tᵢ and calculates the cost of running state sᵢ. In the absence of any dwell time constraints, solving the above equation recursively will provide an optimum sequence s. Because each sᵢ is associated with a tᵢ, the dwell times w can be read off the solution, as the duration for which a stage s; remains the same as the next stage sᵢ₊₁.

Bringing the dwell time constraint into the Bellman equation is still possible. And while the Bellman equation can generate the optimum sequence from any moment in time, such as tᵢ to t₀, it remains possible to introduce and track timers on the optimum path from s₀ to sᵢ. Therefore, any path that violates a dwell time constraint can be ruled out by assigning a high cost to it:

$$V ( {s}_{i + 1} ) = min \{ c ( {s}_{i + 1} ) + V ( {s}_{i} ) + d ( {s}_{i}^{*} , {s}_{i + 1} ) \} i ∈ \{ 0 , 1 , 2 , … , N - 1 \}$$

$$V ( {s}_{0} ) = c ( {s}_{0} )$$

where

$${s}_{i}^{*}$$

is the optimum schedule from si and s0 and d(⋅, ⋅) is a function that gives +∞ if a dwell time constraint is violated on the schedule

$${s}_{i}^{*} ,$$

sᵢ₊₁, i.e., the last stage concatenated with

$${s}_{i}^{*} ,$$

and gives 0 otherwise. In this way, if a solution is found at the end, i.e., IN, the dwell time constraints are ensured to be satisfied.

It should be noted that DP does not include any pressure dynamics p or produced airflow q into the equations. This is because DP on continuous spaces leads to explosion of optimum paths, known as the curse of dimensionality. By restricting the paths to the space of compressor selections, DP becomes tractable. Such a schedule may further be refined by STO to optimize dwell times w further. This schedule can also be used as the initial sequence for iterative STO algorithms.

When scheduling compressors over a long time-horizon, one needs robustness to keep the solution feasible in the future and to be able to react to unexpected demand changes. There are multiple approaches to do this. The first, and most straightforward, approach to handle robustness in this problem is by using a scenario tree. In the scenario tree, the solver wants to fulfill the following for all scenarios: Choose one single control action for the first timestep (k=1) that is a solution for all scenarios; choose a trajectory of control actions for all subsequent time steps (k>1) based on the first control action that is feasible for all scenarios; and minimize the cost for the scenario with the highest certainty of occurring. Alternatively, the problem can minimize the weighted cost of the scenarios based on the certainty of occurrence.

A scenario tree can quickly become very expensive to compute. To limit the scenarios, one can choose to only select the average scenario together with the most extreme scenarios. For compressor control problems, these extreme scenarios are often those with the least consumption and those with the highest consumption.

An alternative way to limit the scenarios is by using a monte carlo simulation. Instead of solving the scenario tree directly, a monte carlo simulation can be performed where the feasibility of each proposed control trajectory is checked across different scenarios. When a proposed control trajectory is violating a simulation, additional constraints will be added to the main optimization problem to propose a new control trajectory that is suitable for these simulations.

Instead of the scenario tree, providing a safety buffer or spare capacity is an alternative way to provide robustness which is less computationally demanding. Here, the problem formulation requires to always have sufficient upload volume available by (i) storing flow in the vessel volume that can be used to provide a higher flow, (ii), keeping sufficient upload in the running compressors, to allow a quick ramp-up of the compressors, or (iii) keeping sufficient compressors running in idling mode to allow a quick start-up of the compressors.

As noted above, exemplary schedulers include mixed integer linear programming (e.g., as CPLEX, Gurobi, Highs or cbc), mixed integer programming on switched systems (e.g., open source solvers such as Bonmin), iterative switching time optimization, and extended dynamic programming. One skilled in the art will recognize that other similar solver approaches may also be implemented depending on the type of application and resources available.

### DETAILED DESCRIPTION

Generally, the compressor systems of the present disclosure comprise one or more compressors configured to provide compressed air or gas to a client network. As described herein, a compressor is provided as a compressed-gas source; however, the compressor system may be provided with other compressed-gas sources, such as a pre-compressed gas tank, reservoir, or a supply pipe or line. The compressor systems may further comprise a vessel or tank for storing compressed air or gas and a valve connected to the client network, where one or more consumers may be present. Further devices such as dryers, filters, regulators, and/or lubricators may also be included.

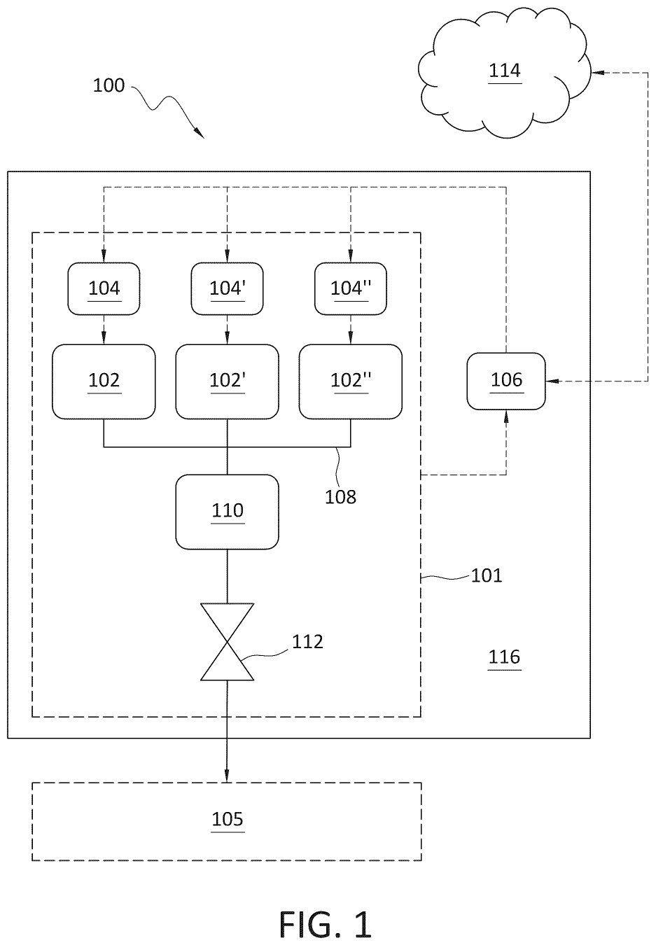

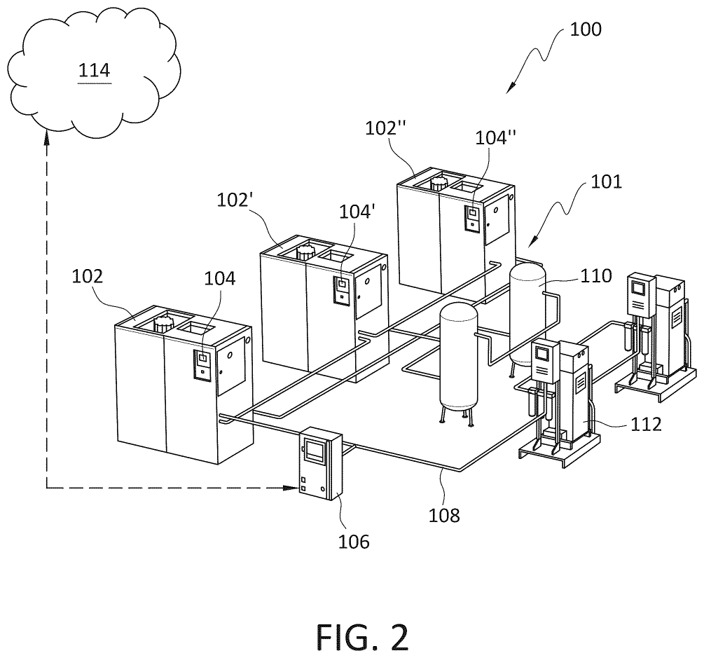

FIGS. 1 and 2 illustrate a hierarchical compressor control method and system 100 (or compressor system 100) comprising a physical hub 101 having one or more compressors 102, 102′, 102″ configured to provide compressed air or gas to a consumer network 105. According to the present disclosure, reference to a single compressor 102 can apply to the one or more compressors 102, 102′, 102″ individually or collectively. The physical hub 101 comprises at least one tank or vessel 110 for storing compressed air or gas and one or more additional utilities 112, (e.g., valves, filters, dryers, aftercoolers/chillers, O2/N2 generators) connected via pipes or ducts 108. In an embodiment, the physical hub 101 is a compressor room. In FIG. 1, full lines indicate fluid connections, whereas broken lines indicate data connections.

The compressors 102, 102′, 102″ may (each) be locally controllable by a respective controller 104, 104′, 104″. According to the present disclosure, reference to a single controller 104 can apply to the one or more controllers 104, 104′, 104″ individually or collectively. Further, to efficiently control the system 100, the controllers 104, 104′, 104″ may be controlled in a coordinated manner. In other words, it may be avoided that each individual controller 104 controls its respective compressor 102, wherein each controller 104 is instructed by a main controller 106 such that the overall performance and efficiency of the system 100 is increased. In an embodiment, the controllers 104, 104′, 104″ are local controllers and the controller 106 is the main controller.

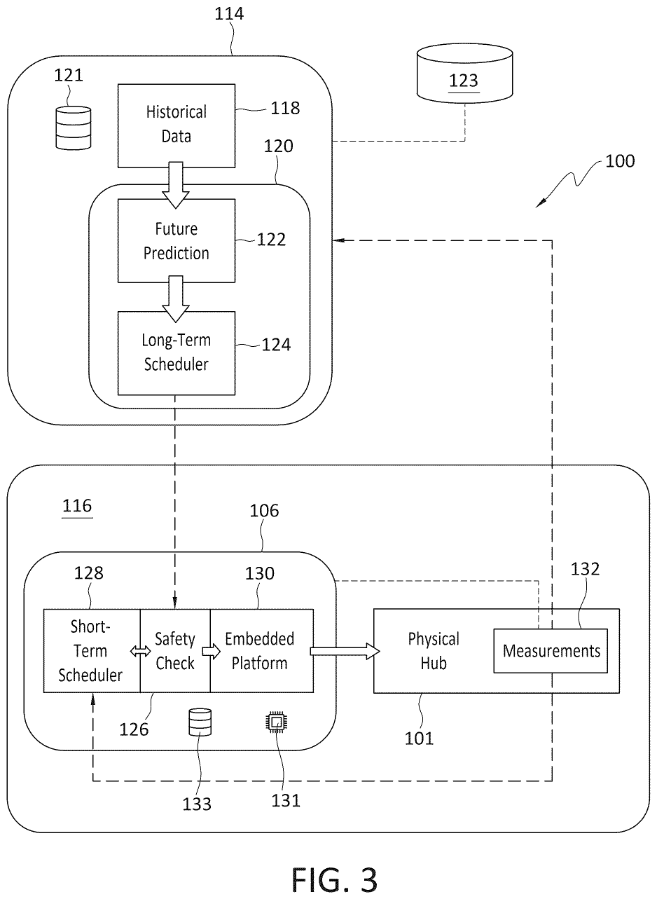

Controllers 104, 106 may comprise a processor (e.g., processor 131 in FIG. 3), for example, a microprocessor, a memory storage (e.g., storage 133 in FIG. 3), an output interface, and an input interface. Controllers 104, 106 may be configured to receive input signals through input interface, which may be received through wired or wireless means, and process received sensor signals obtained from components and related sensors within the system 100. As described herein, controllers 104, 106 may output control signals to components of the system 100 through the output interface. As described in more detail below, based on an embedded platform determination of an optimal schedule for the system 100 using switching time optimization (STO), the main controller 106 transmits control signals to adjust operational parameters of the compressor system. In certain embodiments, controller 106 is configured to transmit control signals to controllers 104 to adjust the operation of the compressor 102, or to turn the compressor 102 on or off, depending on the optimal schedule determined by the main controller 106.

The controller 106 may be located near the controllers 104 but may also be located at a remote position compared to other components of the system 100 while remaining on a safe local network level 116. For example, the controller 106 is not necessarily formed integrally with or coupled to the system 100. The controller 106 may be provided in proximity to the physical hub 101, for example, within the same room volume, or housing. Or, the controller 106 may be remote from the physical hub 101 and components thereof while still being able to receive signals from and transmit signals to the components of the system 100. Further, the controller 106 may be communicatively connected to a remote computer system or service, e.g., for remote monitoring, control, adjustment and/or software updating, etc., and data obtained by the control unit or controller 106 and operation parameters transmitted by controller 106 as control signals may be transmitted to the remote computer system or a data storage device for further analysis and/or processing. In an embodiment, data could pass through a man-in-the-middle, or the customer could provide additional data through another connection. This could allow the customer to share only relevant (filtered) data, or share a production plan with the system.

Controller 106 may include or use a special-purpose or general-purpose computer system, or a computing system, particularly in control unit or controller 106 or alternatively in communication with controller 106, that includes computer hardware, such as, for example, a processor or more than one processor and system memory, as discussed in greater detail below. As noted, the controller 106 may be in relatively close proximity to the physical hub 101 and receive hardwire or wireless signals from other components of the system 100 and send hardwire or wireless signals to other components of the system 100. Alternatively, controller 106 may be arranged remotely from other components of the compressor system and may receive signals from other components of the compressor system, including from one more sensors providing data indicative of one or more operating characteristics in the system 100, and transmit signals to other components of the system over a network, such as a local area network (LAN) or another safe local network. In an embodiment, one of the controllers 104 can be configured to act as the main controller 106 for controlling each compressor 102 of the physical hub 101.

The controller 106 may manage the running, switching, and idle costs of the system 100, thereby reducing the wear of components of the different devices while reducing or otherwise improving the system 100's energy consumption. To this end, the controller 106 may be configured to schedule the operation of components of the system 100 in an optimal manner according to varying embodiments of the present disclosure.

Advantageously, the system 100 is split to include a remote cloud level 114 (i.e., cloud computing environment) and a local network level 116 of the system. The control of the compressor 102 and other components (i.e., vessels 110 and utilities 112) is checked at the local level and verified to be both safe and efficient before implementing scheduled operations. As noted above, safety checking in the main controller 106 at the local network level 116 to verify that the schedule or plan e.g., produced in the cloud environment, is safe to use in the local level protects the physical hub 101 from cyberattacks and hacking. Also, by validating the feasibility of the schedule strategy, the physical hub 101 is prevented from implementing impracticable operations.

FIG. 3 illustrates the hierarchical compressor control system 100 split between the cloud level 114 and local network level 116. At the local network level 116, including the physical hub 101, the main controller 106 is configured to obtain measurements 132 from the one or more compressors 102 for estimating the current state of the one or more compressors 102. The measurements 132 can include constraints such as pressure, flow, temperature, humidity, air quality, speed, acceleration, jerk, vibration, and/or other details pertaining to the status of the compressor 102 and related components (e.g., vessel 110 and utilities 112).

In an embodiment, several demand constraints can be handled by the disclosed method and system 100, including but not limited to: pressure limits or a setpoint pressure; flow demand based on either one of the mixture or of a part of the mixture (e.g. N2 flow, O2 flow); humidity limits; temperature limits; dust particle limits or limits on impurities such as oil in the output fluid; and external limits to follow such as dissolved oxygen in a process.

In an embodiment, several system constraints (e.g., minimum/maximum) can be handled by the disclosed method and system 100, including but not limited to: temperature limits based on inlet of an air utility or booster, motor (windings, converter), element, cooling water, and oil; humidity limits based on the inlet of air utility or booster, prevent unwanted condensation within a pipe or element; flow limits based on maximum inlet flow of an air utility or booster; impurity limits based on inlet of an air utility or booster; speed, acceleration and jerk limitations; valve limitations & rate of change of a valve position; vibrations; maximum current limitations; order between units (compressors, air utility); and time constraints between starts, between stops, minimum/maximum time of a state, delayed second stop.

Measurements 132 are transmitted to both the main controller 106 and cloud level 114 for storage and/or further processing. In an embodiment, the main controller 106 transmits the measurements 132 to the remote cloud level 114. Measurements 132 transmitted to the main controller 106 are processed using a short-term scheduling model 128 to create a short-term schedule having a short-term switching sequence for the operation of one or more compressors 102. In an embodiment, the short-term switching sequence represents a unique sequence of operations of the one or more compressors within a future time period of 1 minute to 60 minutes. The short-term scheduling model 128 of the controller 106 provides a faster reaction time than cloud communication allows. Additionally, the short-term scheduling model 128 offers a fallback solution in case of communication failure between the cloud level 114 and controller 106. In other words, whatever happens at the cloud level 114, i.e., in the event of lost or invalid data, poor prediction, data injection, lost connection, company disestablishment, cloud company bankruptcy, network congestion, or MITM/DDOS attacks at the cloud level 114, the system 100 can still offer reliable control at the local network level 116 for compressor operations. In an embodiment, the cloud level 114 is connected to at least one service 123 that is arranged to perform, e.g., in case of one or more of the aforementioned events, the same operations of future prediction and long-term scheduling at the cloud level 114.

The controller 106 further comprises a safety check module 126 to execute a validation assessment on the short-term schedule, produced by the short-term scheduling model 128, for feasibility and safety. If the short-term schedule “passes” the validation assessment, i.e., if the safety check module 126 deems it feasible and safe, it is sent to an embedded platform 130 comprising switching time optimization (STO) functionality for further refinement of switching times provided with the short-term schedule. The embedded STO capability of the platform 130 refines, optimizes, or otherwise improves the switching times, thereby refining the schedule, at the local level.

The main controller 106 of the system 100 includes the embedded platform 130, which is defined as an embedded MPC-based control algorithm. The MPC-based control algorithm includes an algorithm to handle a broader scope of actuated units, including one or more compressors 102, utilities 112 (such as dryers, valves, aftercoolers-chillers, and O2/N2 generators), oil cooling circuits, and energy recovery systems. The embedded platform 130 can further consider passive units, including one or more vessels 110 and utilities 112 like filters and pipes. When given a sequence (e.g., short-term sequence or long-term sequence), the embedded platform 130 automatically identifies optimal switching times and, given the optimal switching times, refines the given sequence. In an embodiment, the embedded platform 130 includes an STO model that receives a sequence, treats switching times as variables, and optimizes costs, including constraints and consumer requirements. The embedded platform 130 may further include a refinement model that, based on results from the STO model, refines the sequence. For example, if the embedded platform 130 is attempting to allocate zero time to any part of the sequence, such part is removed, and a new sequence is passed, along with an updated starting point, to the embedded platform 130. An exemplary MPC platform (or STO module) is described in WO 2024/141848 A1, published on Jul. 4, 2024, and incorporated herein by reference. The present disclosure relates to a more refined high-level scheduler in the cloud storage 121 as an optimization model or scheduling framework 120. At the remote cloud level 114 of the system 100, a cloud storage 121 and a scheduling framework 120 are provided. The cloud level 114 provides such resources to solve a difficult optimization problem required for determining a long-term schedule of the compressor 102. The cloud level 114 advantageously allows for easy replacement of prediction or scheduling algorithms. Depending on different forecasts, multiple possible schedules can be provided at the cloud level 114, wherein the most probable results are shared with the main controller 106 at the local network level 116.

The cloud storage 121 comprises historical data 118 of the measurements 132 obtained from the physical hub 101. The historical data 118 is fed into the scheduling framework 120 for processing. The scheduling framework 120 provides an optimization-based control solution to address the challenges at the physical hub 101 within the local network level 116. The scheduling framework 120 calculates, at each discrete control instance (sampling time), the control sequence over a finite-time horizon by solving an optimal control problem based on (1) an estimate of the current system state, (2) an estimate of the demand and disturbances, (3) an available system model and (4) by accounting for system constraints. The first element of this optimal control sequence is then applied to the system 100, and this procedure is repeated the next sample time.

MPC has several advantages compared to the existing technology. The first advantage is the usage of the finite-time horizon, which takes future consumption estimates into account. Considering these estimates, a more optimal set of compressors 102, 102′, 102″ can be selected to reduce the energy consumption over the complete time horizon. Second, within compressor room controller 106, there are complex goals that cannot easily be expressed into typical control specifications such as bandwidth, overshoot, steady-state, or tracking error. Such complex goals include, for example, minimal power consumption, flow requirements, equal distribution of running hours for the compressors, etc. The scheduling framework 120 can explicitly handle these goals through the objective functions and constraints considered in the optimal control that is solved. A third advantage of the optimization model is that it can be made robust against large uncertainties. Due to the slow response time of a compressor 102 and the uncertainties on the requested flow of a consumer, addressing such uncertainties helps maintain stability (e.g., pressure stability) throughout the system 100.

The scheduling framework 120 is arranged to depend on system models, predictions of disturbances, and consumer requirements. Without excessive tuning, an efficient and effective solution can be provided to the consumer that works in all circumstances, including special cases such as overpressure due to a sudden drop in consumption, start-up behavior, and compressor shutdowns. The end user can be shielded from numerous issues by properly formulating the optimal control problem and implementing reliable numerical solvers. The achievable performance depends on the scheduling framework 120 and the accuracy of the provided information (e.g., measurements 132).

The scheduling framework 120 is further arranged to solve mixed integer problems. A mixed integer problem exists where one or more decision variables are constrained to integer values. Such makes the optimization problem non-convex and, therefore, more difficult to solve. It is expected that tailored solutions, based on knowledge and characteristics of the physical hub 101, will be required to yield an optimal control solution that can run on the embedded, main controller 106 at a given control cycle time. Because different elements of the system 100 exhibit different characteristics (e.g., active vs passive components), different time scales are present in the mixed integer problem. Such different time scales include the change of a motor speed or valve position, which requires a few seconds, and time necessary to switch between states, which can take several minutes.

Based on historical measurements 118 in the cloud storage 121, the scheduling framework 120 uses a prediction module 122. The prediction module 122 may consider factors such as consumer demand, inlet air (e.g., atmospheric conditions based on weather information), humidity, temperature, and impurities at multiple locations within the system 100. The future demand prediction from the prediction module 122 is transmitted to a long-term scheduling model 124 to create a long-term schedule having a long-term switching sequence for the operation of one or more compressors 102. In an embodiment, the future demand prediction is determined from one or more of artificial intelligence (AI), heuristics and user-defined profiles. In an embodiment, the long-term scheduling model 124 incorporates iterative switching time optimization (ISTO), e.g., described in described in WO 2024/141848 A1, in addition to switching times, and refines the sequence based on the value of switching times in an iterative manner, thereby refining the schedule.

In an embodiment, the iterative STO capability, i.e., to refine switching times and the sequence based on the value of switching times in an iterative manner, is not provided with the embedded platform 130 and is instead only provided with the long-term scheduling model 124 to refine switching times and the sequence based on the value of switching times in an iterative manner, wherein the embedded platform 130 is provided with short-term STO to refine the switching times. Such an embodiment allocates sufficient time to both refining the sequence as well as switching times. In an embodiment, the short-term scheduling model 128 updates within 20 ms and 10 seconds, preferably every 0.5 to 1 second. The long-term scheduling model depends on the horizon of the short-term scheduler and provides one update every ¼ of the horizon (e.g., for a short-term horizon of 1 minute, every 15 seconds, and for a short-term horizon of 60 minutes, every 15 minutes) or at least ½ of the short-term horizon.

In an embodiment, the long-term switching sequence represents a unique sequence of operations of the one or more compressors 102 within a future time period of 1 hour to 48 hours. Preferably, the long-term scheduling model 124 considers a compressor's “worst-case” minimum cycle time, which, for example, can take up to 8 hours and lead to a complicated mixed integer problem to solve in real-time. Following the creation of the long-term schedule, the long-term schedule is transmitted from the cloud level 114 to the local network level 116 for further processing.

The main controller 106, after receiving the long-term schedule, uses the safety check module 126 to perform a validation assessment on the long-term schedule for feasibility and safety. If the long-term schedule “passes” the validation assessment, i.e., if the long-term schedule is deemed by the safety check module 126 as being feasible and safe, the long-term schedule is sent to the embedded platform 130 for further refinement of switching times provided with the long-term schedule using switching time optimization (STO). The safety check module 126 is arranged to automatically determine whether to implement the long-term switching sequence or short-term switching sequence for the operation of one or more compressors 102 based on the validation assessment.

In an embodiment, following validation of the long-term schedule, the safety check module 126 implements the long-term switching sequence by default. The cloud level 114 offers greater computational capability and better predictions over time because software and programs within the cloud can be easily and regularly updated. The cloud level 114 also reduces costs of the overall system because more computation can be performed at the cloud level 114, rather than using expensive hardware at the physical hub 101.

As noted above, the safety check module 126 can prevent the long-term schedule from being sent to the embedded platform 130 in response to an invalid result obtained from the validation assessment for said long-term schedule. Invalid results may occur in the event of lost or invalid data, poor prediction, data injection, lost connection, company disestablishment, cloud company bankruptcy, network congestion, or MITM/DDOS attacks at the cloud level 114. Following such invalid results for the long-term schedule, the safety check module 126 implements the short-term switching sequence.

Advantageously, the disclosed method and system 100 allow for improved energy efficiency, both in production as well as in recuperation, and reduced wear and service costs, thereby increasing the lifetime of critical and expensive equipment. The present disclosure introduces a solution that improves overall energy-efficiency of compressed air systems while achieving robustness and safety by proposing a system and method that splits the control problem of compressed air systems efficiently into manageable, smaller scheduling and prediction problems that can be solved by a hierarchical compressor control system.

Embodiments of the disclosure may comprise or utilize a special-purpose or general-purpose computer system (e.g., system 100) that includes computer hardware, such as, for example, one or more controllers 104, main controller 106, at least one processor 131, and system memory and storage (e.g., computer storage media 133), as discussed in greater detail above. Embodiments within the scope of the present disclosure include physical and other computer-readable media for carrying or storing computer-executable instructions and/or data structures. Such computer-readable media can be any available media that a general-purpose or special-purpose computer system can access. Computer-readable media that store computer-executable instructions and/or data structures are computer storage media 133. Computer-readable media that carry computer-executable instructions and/or data structures are transmission media. Thus, by way of example, embodiments of the disclosure can comprise at least two different kinds of computer-readable media: computer storage media and transmission media.

Computer storage media are physical storage media that store computer-executable instructions and/or data structures. Physical storage media include computer hardware, such as random access memory (RAM), read-only memory (ROM), electrically erasable programmable ROM (EEPROM), solid state drives (SSDs), flash memory, phase-change memory (PCM), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality.

Transmission media can include a network and/or data links that can be used to carry program code in the form of computer-executable instructions or data structures and which can be accessed by a general-purpose or special-purpose computer system. A “network” is defined as one or more data links enabling electronic data transport between computer systems and/or modules and/or other electronic devices. When information is transferred or provided over a network or another communications connection (either hardwired, wireless, or a combination of hardwired or wireless) to a computer system, the computer system may view the connection as transmission media, combinations of the above should also be included within the scope of computer-readable media. Further, upon reaching various computer system components, program code in the form of computer-executable instructions or data structures can be transferred automatically from transmission media to computer storage media (or vice versa). It should be understood that computer storage media can be included in computer system components that also (or even primarily) utilize transmission media.

Computer-executable instructions comprise, for example, instructions and data which when executed with one or more processors or applications, cause a general-purpose computer system, special-purpose computer system, or special-purpose processing device to perform a certain function or group of functions. Computer-executable instructions may include binaries, intermediate format instructions such as assembly language, or even source code.

It will be appreciated that the disclosed systems and methods may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. Embodiments of the disclosure may also be practiced in distributed system environments where local and remote computer systems are linked (either by hardwired data links, wireless data links, or by a combination of hardwired and wireless data links) through a network, and both perform tasks. As such, in a distributed system environment, a computer system may include a plurality of constituent computer systems. In a distributed system environment, program modules may be located in local and remote memory storage devices.

It will also be appreciated that the embodiments of the disclosure may be practiced in a cloud computing environment. Cloud computing environments or remote cloud level may be distributed, although this is not required. When distributed, cloud computing environments may be distributed internationally within an organization and/or have components possessed across multiple organizations. In this description, “cloud computing” is defined as a model for enabling on-demand network access to a shared pool of configurable computing resources (e.g., networks, servers, storage, applications, and services). A cloud computing model can have various characteristics, such as on-demand self-service, broad network access, resource pooling, rapid elasticity, measured service, etc. A cloud computing model may also come in the form of various service models, such as software as a Service (SaaS), Platform as a Service (PaaS), and Infrastructure as a Service (IaaS). The cloud computing model may also be deployed using different deployment models such as private, community, public, hybrid, etc. Although the subject matter has been described in language specific to structural features and/or methodological acts, it is to be understood that the subject matter defined in the appended claims is not necessarily limited to the features or acts described above, or the order of the acts described above. Rather, the described features and acts are examples of implementing the claims.

The present disclosure may be embodied in other specific forms without departing from its essential characteristics. Such embodiments may include a data processing device comprising means for carrying out one or more of the methods described herein; a computer program comprising instructions which, when a computer executes the program, cause the computer to carry out one or more of the methods described herein; and/or a computer-readable medium comprising instructions which, when executed by a computer, cause the computer to carry out one or more of the methods described herein. The described embodiments are to be considered in all respects only as illustrative and not restrictive. All changes that come within the meaning and range of equivalency of the claims are to be embraced within their scope.

It will be understood that although the terms first, second, etc. may be used herein to describe various elements, these elements should not be limited by these terms. These terms are only used to distinguish one element from another. For example, a first element could be termed a second element. Similarly, a second element could be termed a first element without departing from the scope of the present invention. As used herein, the term “and/or” includes any combinations of one or more of the items listed in the associated list. It is further understood that relational terms such as first and second, and the like are used solely to distinguish one entity from another without necessarily requiring or implying any such relationship or order between such entities.

It is to be understood that even though numerous characteristics and advantages of various embodiments of the present disclosure have been outlined in the foregoing description, together with details of the structure and function of various embodiments thereof, this detailed description is illustrative only. Changes may be made in detail, especially in matters of structure and arrangements of parts within the principles of the present disclosure to the full extent indicated by the broad general meaning of the terms in which the appended claims are expressed.

The project leading to this application has received funding from the European Union's Horizon 2020 research and innovation program under the Marie Sklodowska-Curie grant agreement No. 953348.

1. A method for controlling a compressed air or gas system including one or more compressors configured to provide compressed air or gas to one or more consumers, the method comprising the steps of:
at a local network level of the compressed air or gas system,
obtaining measurements from the one or more compressors for estimating a current state of the one or more compressors;
transmitting the measurements to a remote cloud level of the compressed air or gas system;
transmitting the measurements to a short-term scheduling model to create a short-term schedule having a short-term switching sequence for operation of the one or more compressors;
performing a validation assessment on the short-term schedule for feasibility and safety using a safety check module; and
sending the short-term schedule, following validation, to an embedded platform on a controller of the compressed air or gas system, wherein the embedded platform is arranged to refine the short-term switching sequence before implementation on the one or more compressors using switching time optimization;
at the remote cloud level of the compressed air or gas system,
storing the measurements from the one or more compressors in a cloud storage;
based on stored measurements in the cloud storage, producing a future demand prediction for the one or more compressors using a prediction module;
transmitting the future demand prediction to a long-term scheduling model to create a long-term schedule having a long-term switching sequence for operation of the one or more compressors; and
transmitting the long-term schedule to the local network level of the compressed air or gas system;
the method further comprising the steps of:
performing the validation assessment on the long-term schedule for feasibility and safety using the safety check module; and
sending the long-term schedule, following validation, to the embedded platform embedded with the controller of the compressed air or gas system, wherein the embedded platform is arranged to refine the long-term switching sequence before implementation on the one or more compressors;
wherein the safety check module is arranged to automatically determine whether to implement the long-term switching sequence or short-term switching sequence for operation of the one or more compressors based on the validation assessment.

2. The method according to claim 1, wherein the safety check module implements the long-term switching sequence by default following validation of the long-term schedule.

3. The method according to claim 1, wherein the safety check module prevents the long-term schedule from being sent to the embedded platform in response to an invalid result obtained from the validation assessment for said long-term schedule.

4. The method according to claim 3, wherein the safety check module implements the short-term switching sequence after the validation assessment obtains the invalid result for said long-term schedule.

5. The method according to claim 1, wherein the safety check module evaluates the long-term schedule in view of the measurements from the one or more compressors obtained for estimating the current state of the one or more compressors.

6. The method according to claim 1, wherein the long-term scheduling model creates multiple long-term schedules based on multiple future demand predictions.

7. The method according to claim 6, wherein the long-term schedule transmitted to the local network level of the compressed air or gas system is selected from the multiple long-term schedules and derived from the future demand prediction with a most probable outcome.

8. The method according to claim 7 further comprising, at the remote cloud level of the compressed air or gas system, using an optimal control (OCP) model including the prediction module to achieve a long-term schedule, by solving a mixed integer problem based on one or more costs, requirements, and constraints associated with the one or more compressors.

9. The method according to claim 1, wherein the future demand prediction is determined from one or more of artificial intelligence (AI), heuristics and user-defined profiles.

10. The method according to claim 1, wherein the long-term scheduling system is determined by one or more of dynamic programming, analytic dynamic programming (ADP), genetic algorithms, heuristics, a branch and bound scheme, a linear program simplex solver and cutting algorithms or other advanced mixed-integer nonlinear programming solvers.

11. The method according to claim 1 wherein at least one of
the short-term switching sequence represents a unique sequence of operations of the one or more compressors within a future time period of 1 minute to 60 minutes, and
the long-term switching sequence represents a unique sequence of operations of the one or more compressors within a future time period of 1 hour to 48 hours.

12. A hierarchical compressor control system comprising:
at a local network level of the system,
one or more compressors configured to provide compressed air or gas to one or more consumers; and
a main controller including at least one processor and one or more hardware storage devices that store instructions that are executable to cause the controller to:
obtain measurements from the one or more compressors for estimating a current state of the one or more compressors;
transmit the measurements to a remote cloud level of the system;
transmit the measurements to a short-term scheduling model to create a short-term schedule having a short-term switching sequence for operation of the one or more compressors;
perform a validation assessment on the short-term schedule for feasibility and safety using a safety check module; and
send the short-term schedule, following validation, to an embedded platform on the main controller of the system, wherein the embedded platform is arranged to refine the short-term switching sequence before implementation on the one or more compressors using switching time optimization;
the system further comprising:
at the remote cloud level of the system,
a scheduling framework; and
a cloud storage that stores the measurements from the one or more compressors and further stores instructions that are executable to cause the scheduling framework to:
based on stored measurements in the cloud storage, produce a future demand prediction for the one or more compressors using a prediction module;
transmit the future demand prediction to a long-term scheduling model to create a long-term schedule having a long-term switching sequence for operation of the one or more compressors; and
transmit the long-term schedule, and optionally the future demand prediction, to the local network level of the system;
wherein the controller is further configured to:
perform the validation assessment on the long-term schedule for feasibility and safety using the safety check module; and
send the long-term schedule, following validation, to the embedded platform embedded with the controller of the system, wherein the embedded platform is arranged to refine the long-term switching sequence before implementation on the one or more compressors;
wherein the safety check module is arranged to automatically determine whether to implement the long-term switching sequence or short-term switching sequence for operation of the one or more compressors based on the validation assessment.

13. The system according to claim 12, wherein the safety check module implements the long-term switching sequence by default following validation of the long-term schedule.

14. The system according to claim 12, wherein the safety check module prevents the long-term schedule from being sent to the embedded platform in response to an invalid result obtained from the validation assessment for said long-term schedule.

15. The system according to claim 14, wherein the safety check module implements the short-term switching sequence after the validation assessment obtains the invalid result for said long-term schedule.

16. The system according to claim 12, wherein the safety check module evaluates the long-term schedule in view of the measurements from the one or more compressors obtained for estimating the current state of the one or more compressors.

17. The system according to claim 12, wherein the long-term scheduling model creates multiple long-term schedules based on multiple future demand predictions.

18. The system according to claim 17, wherein the long-term schedule transmitted to the local network level of the system is selected from the multiple long-term schedules and derived from the future demand prediction with a most probable outcome.

19. The system according to claim 12, wherein the future demand prediction is determined from one or more of artificial intelligence (AI), heuristics and user-defined profiles.

20. A controller configured to operate a compressor system having one or more compressors, the controller comprising:
a processor; and
a computer readable storage medium that stores instructions that are executable to cause the controller to:
obtain measurements from the one or more compressors for estimating a current state of the one or more compressors;
transmit the measurements to a remote cloud level of the compressor system;
transmit the measurements to a short-term scheduling model to create a short-term schedule having a short-term switching sequence for operation of the one or more compressors;
perform a validation assessment on the short-term schedule for feasibility and safety using a safety check module;
send the short-term schedule, following validation, to an embedded platform on the controller, wherein the embedded platform is arranged to refine the short-term switching sequence before implementation on the one or more compressors using switching time optimization;
receive a long-term schedule originating from the remote cloud level of the compressor system and generated using a prediction module and the long-term scheduling model at remote cloud level of the compressor system;
perform the validation assessment on the long-term schedule for feasibility and safety using the safety check module; and
send the long-term schedule, following validation, to the embedded platform on the controller, wherein the embedded platform is arranged to refine the long-term switching sequence before implementation on the one or more compressors using switching time optimization;
wherein the safety check module is arranged to automatically determine whether to implement the long-term switching sequence or short-term switching sequence for operation of the one or more compressors based on the validation assessment.
